(19) United States
(12) Patent Application Publication
(10) Pub. No.: US 2008/0079690 A1
(43) Pub. Date: Apr. 3, 2008

(54) Portable device and server with streamed user interface effects

(75) Inventor: Eral Denis Foxenland, Malmo (SE)

Correspondence Address: ALBIHNS STOCKHOLM AB, BOX 5581, LINNEGATAN 2, SE-114 85 STOCKHOLM; SWEDENn, STOCKHOLM, omitted

(73) Assignee: SONY ERICSSON MOBILE COMMUNICATIONS AB, Lund (SE)

(21) Appl. No.: 11/564,857

(22) Filed: Nov. 30, 2006

Related U.S. Application Data
(60) Provisional application No. 60/827,726, filed on Oct. 2, 2006.

(51) Int. Cl. G09G 5/00

(52) U.S. Cl. 345/156

(57) ABSTRACT

The invention relates to a portable device (1) having wireless capability and a basic user interface (2) that may be enhanced by objects temporarily downloaded or streaming to the device. Effects of the temporary objects may be added on the basic user interface. The portable device is connectable to a server (10) or any type of external memory/processor source. The portable device is arranged to establish a connection with the external memory/processor source, and to stream down user interface effects, and/or code to control user interface effects from the external memory/processor source so that the effects may be used with the basic user interface. The present invention also relates to a corresponding server.

### FIELD OF THE INVENTION

The present invention relates to a portable device having wireless capability and a basic user interface that may be enhanced by objects temporarily downloaded or streaming to the device. Effects of the temporary objects may be added on the basic user interface. The present invention also relates to a corresponding server.

### BACKGROUND OF THE INVENTION

Today portable devices such as mobile telephones require very large and complicated user interfaces to provide visual moving graphics, sound effects etc. to differentiate from competitors, to increase usability and potential of relatively large, high resolution displays. The user interface demands more and more memory, both for the visual content itself and for all additional calculation needed. Many of today's effects and elaborate user interface behaviors that take up memory are only experienced by the user a fraction of the total usage time. The rest of the time it just “sits there” and takes up valuable memory space. There is a relatively limited amount of memory in today's portable, small devices.

On the other hand, greater and greater bandwidth is available in portable devices. The bandwidth is conventionally utilized for streaming for accessing audio and video files. Only a small part of a streamed file is stored in a temporary buffer while the remainder of the file is downloaded in “real time” as the user is enjoying or otherwise using the file content. Thus, memory space is saved in the device which does not have to store the whole file to use it.

In the present invention, the same is done with the entire or parts of the user interface (all aspects of the user interface ) so that parts of the code, e.g. the “brain” and control of the user interface, is outsourced externally of the portable, wireless device, suitably to a server connectable with the device. With the present invention there is a way to add a lot more advanced and usability promoting user interface effects for a better user experience, and some or all control code thereof, without wasting any of the static memory.

### SUMMARY OF THE INVENTION

An object of the invention is to provide a device in which the entire or parts of the user interface is run in streaming mode to save memory space in the device.

A further object of the invention is to provide a device in which parts of the user interface is streamed to be added on a basic user interface as overlay effects.

In a first aspect the invention provides a portable device with a basic user interface and wireless capability for connection to a server or any type of external memory/processor source. The portable device is arranged to establish a connection with the external memory/processor source, and to stream down user interface effects, and/or code to control user interface effects from the external memory/processor source so that the effects may be used with the basic user interface.

Suitably, the device is arranged to send feedback to the external memory/processor source for controlling when to stream what effects.

Suitably, the device is arranged to predict a subsequent batch of effects, trigger the download of a predicted subsequent batch of effects, preparing streaming of predicted effects, and downloading temporary code.

Preferably, the device is arranged to predict the subsequent batch of effects during the transition time when moving from one part of the basic user interface to another.

Suitably, the device is arranged to connect to the external memory/processor source during the transition time.

Suitably, the device is arranged to discard the last used user interface effect from the memory buffer, when a new user interface effect is activated.

In one embodiment, the device is arranged to stream overlay user interface effects to be added on the basic user interface.

The device may be arranged to link user interface effects to other data streaming down.

The device may be arranged to run the other data streaming down in a specific application, and to add on user interface effects to a user interface specific to said application.

The device is a mobile telephone, a pager, a communicator, a smart phone, or an electronic organiser.

In a second aspect the invention provides a server acting as external memory/processor source for cooperation with a device as mentioned above.

Suitably, the server is connectable to a portable device with a basic user interface and wireless capability. The server is arranged to be connected to the portable device, and to stream down user interface effects, and/or code to control user interface effects from the server.

Suitably, the server is arranged to receive feedback from the device for controlling when to stream what effects.

The server may be arranged to link user interface effects to other data streaming down.

### BRIEF DESCRIPTION OF THE DRAWINGS

The invention will be described in detail below with reference to the accompanying drawing of which:

FIG. 1 is a schematic representation of an embodiment of the invention.

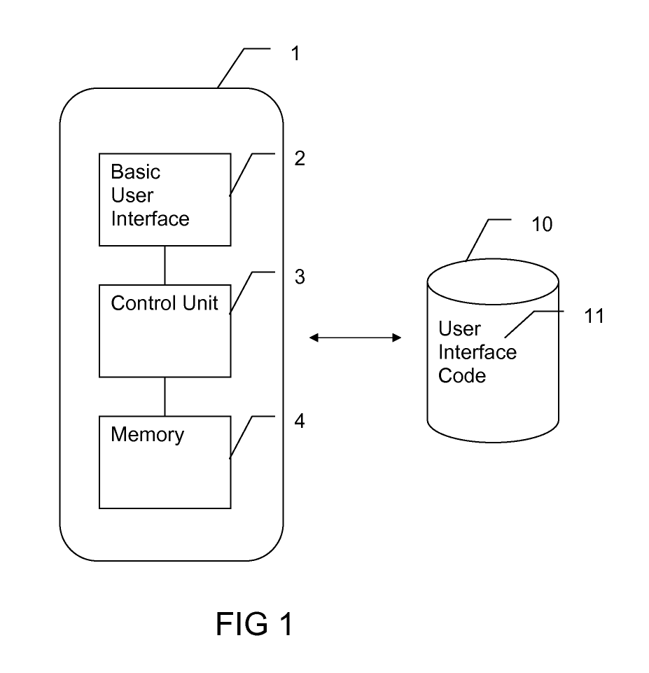

### DETAILED DESCRIPTION OF PREFERRED EMBODIMENTS

The present invention is for example applicable in electronic devices such as a mobile telephones, pagers, communicators, smart phones, or electronic organisers. The present invention is applicable and suitable for all portable devices with visual interface and wireless capability, connectable to a server or any type of external memory/processor source. The description is focussed on components relevant to the specific objects and functions of the invention while other components may be conventional.

A portable device 1, e.g. a mobile phone, comprises conventional components such as radio interfaces for wireless communication, keypad etc. (not shown). A standard application or generic basic user interface 2 comprises a keypad, a visual display, and a speaker system with a loudspeaker and/or a headset. The keypad may comprise a touch screen or other forms of adaptable buttons. Software portions of the user interface is stored permanently in a memory 3 and controlled by a control unit 2.

According to embodiments of the present invention, additional software portions of the user interface are stored externally of the device 1, suitably in a server 10 or any type of external memory/processor source, connectable by the device 1 through a radio interface. As is conventional in mobile telephones, the device 1 is adapted to access wireless networks, such as the Internet and/or other local and wide area networks (LAN/WAN). The server 10 is provided with a large memory and permanently stores user interface code which may be streamed to the device 1 through the wireless connection. Entire user interface functions and overlay effects are stored as content items or files. When a user interface function or overlay effect is needed, only a part of the file is stored in a buffer in the memory 3 of the device 1, in a streaming session between the device 1 and the server 10.

Thus, the user interface may be enhanced temporarily with rich visual/audio effects far beyond what is possible with the limited memory 4 of the device 1. User interface effects are streamed down to be stored temporarily in the buffer of the memory 3, in real time a short time before needed, when user interacts within a particular part of the basic user interface 3, to be discarded directly thereafter for saving valuable memory space.

In other words, user interface effects, and code to control the effects, partially reside in the server 10. The device 1 will then send feedback and control signals to the server 10 controlling when to stream what effects which may depend both on where in the basic user interface 3 the user interacts and what feedback that this generates.

The basic user interface 3 components can be “spiced up” to a very different level then what exists in today's devices by having partial user interface effects streamed down and played “on top” of the standard user interface 3, when used by the user. The streaming effects reside in a temporary memory buffer where it can receive commands from the basic user interface 3, and communicate back to the server 10. Also synchronization code needed to interact with the code of the basic user interface 3 in the device 1 should only be downloaded and/or streamed when necessary.

There is a short transition time when moving from one part of the basic user interface 3 to another which can be used to connect to the server 10 to control what types/part of effects that should be streamed into the device next. In some cases it is also possible to predict what part of the user interface that the user will go to/access next that could further prepare the effects at hand. The device is triggering the download of next batch of effects, preparing streaming of overlay user interface effects video (explained later), downloading temporary code etc. and when activated, the last used parts of the streamed user interface code is discarded from the memory buffer.

For example, when the user has placed a highlight in a play list, the device detects the type of item highlighted and predicts that the next user step is moving the highlight or starting to play. Before the user has made the next choice, the device starts to download of next predicted batch of effects. If the prediction is correct, the delay involved with the streaming is decreased, if not another downloaded should be started. The device signals information to the server about user actions or about requested effects to be streamed down.

In one embodiment, a full or partial screen overlay with partial transparency in different grades is synchronized with transitions/effects currently used by the user. For example, moving of a highlight in a list might be handled by the internal basic user interface 3 but a glow effect when hitting every text item, could be streamed down and added “on top of” the moving of the highlight. Code for this synchronization could reside in the memory 3 of the device, at least temporarily, and/or on the server 10.

The possibility for much more personalized, fun and interesting user interface effects will become true. The present invention enables much more diversified effects. In the phone book's contact list e.g. every contact could have a different effect depending on different personal preferences. If one of one's friends has a personal background in a pink pattern for precise info, this could be reflected in the highlight when positioned over that contact, in the background of that person's SMS etc. Calendar, time of day, and/or location dependent effects can be achieved in a similar manner.

Further examples of varying effects include different effects when making a small jump in a list compared to a long jump, jumping between different levels in applications, deleting one item is associated with a smaller effect than deleting many items etcetera.

The server 10 can be controlled by a telecommunications operator. This gives the operator the possibility to customize specific functions, with respect to the user interface. Thus, when a user is using a specific operator, some functions will have an operator-specific user interface.

In a further embodiment of the present invention the user interface effects are also linked to other items streaming down, like music and video and other content items.

As the music streams down, tailor-made, adapted to the artist, style etc, user interface effects could play, at chosen parts of the user interface (e.g. in music player mode). These effects are streamed together with the music (like some kind of temporary metadata) and when the song is over, erased from the temporary memory buffer. The association link between the user interface effects and the content item may be made in the server that streams both the effect and the item. The link may alternatively be made in the portable device which synchronizes the effect in the user interface. The effect and the item can also be streamed from different servers. For example, a visual effect can be linked to an audio content and be streamed from different sources. When a track is selected from a play list in audio player mode, a special icon or image may be shown.

Merits and advantages of the invention are e.g.:
No permanent consumption of static memory for elaborate, highly memory consuming user interface effects, like sound, moving graphics, video etc.
More personalized effects (more types of effects per transition, position in lists etc. possible). Special user interface transitions depending on external events, time of day, positioning.
Customization for operators will be possible. The operator could build much more rich user interface “overlays”, in a much more creative way utilizing much more memory heavy content, stored, and run (with device or operator specific code) on their own servers. More of the work outsourced to the operators but still manufacturer control over general user interface behavior etc.

The invention has been described with a certain degree of particularity, but modifications and variations may occur to persons skilled in the art. The scope of the invention is only limited by the claims below.

1. A portable device with a basic user interface and wireless capability for connection to a server or any type of external memory/processor source, wherein the portable device is arranged to establish a connection with the external memory/processor source, and to stream down user interface effects, and/or code to control user interface effects from the external memory/processor source so that the effects may be used with the basic user interface.

2. A portable device according to claim 1, wherein the device is arranged to send feedback to the external memory/processor source for controlling when to stream what effects.

3. A portable device according to claim 1, wherein the device is arranged to predict a subsequent batch of effects, trigger the download of a predicted subsequent batch of effects, preparing streaming of predicted effects, and downloading temporary code.

4. A portable device according to claim 3, wherein the device is arranged to predict the subsequent batch of effects during the transition time when moving from one part of the basic user interface to another.

5. A portable device according to claim 4, wherein the device is arranged to connect to the external memory/processor source during the transition time.

6. A portable device according to claim 3, wherein the device is arranged to discard the last used user interface effect from the memory buffer, when a new user interface effect is activated.

7. A portable device according to claim 1, wherein the device is arranged to stream overlay user interface effects to be added on the basic user interface.

8. A portable device according to claim 1, wherein the device is arranged to link user interface effects to other data streaming down.

9. A portable device according to claim 1, wherein the device is arranged to run the other data streaming down in a specific application, and to add on user interface effects to a user interface specific to said application.

10. A portable device according to claim 1, wherein the device is a mobile telephone, a pager, a communicator, a smart phone, or an electronic organiser.

11. A server connectable to a portable device with a basic user interface and wireless capability, wherein the server is arranged to be connected to the portable device, and to stream down user interface effects, and/or code to control user interface effects from the server.

12. A server according to claim 11, wherein the server is arranged to receive feedback from the device for controlling when to stream what effects.

13. A server according to claim 11, wherein the server is arranged to link user interface effects to other data streaming down.

14. A server acting as external memory/processor source for cooperation with a device with a basic user interface and wireless capability for connection to a server or any type of external memory/processor source, wherein the portable device is arranged to establish a connection with the external memory/processor source, and to stream down user interface effects, and/or code to control user interface effects from the external memory/processor source so that the effects may be used with the basic user interface.
